(19) United States
(12) Patent Application Publication
(10) Pub. No.: US 2008/0060864 A1
(43) Pub. Date: Mar. 13, 2008

(54) Motorcycle

(75) Inventor: Nobuhiro ARAI, Shizuoka (JP)

Correspondence Address: HOGAN & HARTSON L.L.P., 1999 AVENUE OF THE STARS, SUITE 1400, LOS ANGELES, CA, 90067, US

(73) Assignee: YAMAHA HATSUDOKI KABUSHIKI KAISHA, Iwata-shi (JP)

(21) Appl. No.: 11/848,067

(22) Filed: Aug. 30, 2007

(30) Foreign Application Priority Data
Sep. 11, 2006 (JP) 2006-245349

(51) Int. Cl. B62K 11/00; F01N 3/035; F01N 7/00

(52) U.S. Cl. 180/219; 180/309; 60/276; 60/299

(57) ABSTRACT

A motorcycle in which a pre-catalyst is disposed in an exhaust pipe to purify exhaust gas. The pre-catalyst is installed away from a rider's leg. A main frame extends longitudinally. An engine is mounted on the main frame and has an exhaust opening. An exhaust pipe extends forward from the exhaust opening, curves and then extends rearward. A pre-catalyst is disposed in the exhaust pipe. The exhaust pipe is positioned between the engine and the main frame, as seen from above. The pre-catalyst is positioned inside of an outside end of the main frame.

### RELATED APPLICATIONS

This application claims the benefit of priority under 35 USC 119 of Japanese patent application nos. 2006-245349, filed on Sep. 11, 2006, which application is hereby incorporated by reference in its entirety.

### BACKGROUND OF THE INVENTION

1. Field of the Invention

The present invention relates to a motorcycle, and in particular to a motorcycle having an exhaust pipe in which a catalyst is disposed to purify exhaust gas.

2. Description of Related Art

Exhaust purifying devices for motorcycles in which a main catalyst is disposed in a silencer and a pre-catalyst is disposed in an exhaust pipe are known. Exhaust gas is purified when it passes through the main catalyst and the pre-catalyst (see JP-A-2006-9648, page 6 and FIG. 3, for example).

JP-A-2006-9648 discloses an exhaust purifying device for a motorcycle including: an exhaust pipe extending forward from an exhaust opening of an engine and extending downward and further extending rearward; and a pre-catalyst disposed in the exhaust pipe. The exhaust pipe passes by one side of a cylinder body. The pre-catalyst is positioned on the one side of the cylinder body.

The sole use of a main catalyst installed in a muffler is often insufficient for purification of exhaust gas due to a lower temperature of the exhaust gas. This is because the main catalyst is usually far away from the exhaust opening, so that the temperature of the exhaust gas is lower by the time it reaches the catalyst. The additional use of the pre-catalyst aims at smooth purification of exhaust gas. However, efficient purification of exhaust gas requires high exhaust gas temperatures. The pre-catalyst will typically have high interior temperatures of 800 to 900° C., for example. It is thus critical to protect a rider's leg against radiation heat from a portion of the exhaust pipe where the pre-catalyst is installed.

According to JP-A-2006-9648, however, the pre-catalyst is arranged near the cylinder body for earlier activation of exhaust gas. As a result, the pre-catalyst is disposed proximate to the rider's leg. Thus, measures must be taken against damage due to heat. When the pre-catalyst is installed in a rear part of the exhaust pipe (a position closer to the silencer), efficient purification will not be achieved. When a heat insulating plate is provided on the outside of the exhaust pipe, the insulating plate itself may become very hot, or in some cases, may melt depending on the material used.

### SUMMARY OF THE INVENTION

The present invention provides a motorcycle in which a pre-catalyst is disposed in an exhaust pipe to purify exhaust gas, and the pre-catalyst is installed away from the rider's leg.

One embodiment of the present invention is a motorcycle including: a main frame extending longitudinally; an engine mounted to the main frame and having an exhaust opening; an exhaust pipe extending forward from the exhaust opening, curving and then extending rearward; and a catalyst disposed in the exhaust pipe. The exhaust pipe is positioned between the engine and the main frame, as seen from above, and the catalyst is positioned inside of an outside end of the main frame.

In another embodiment, the engine has a crankcase on one side in a vehicle width direction, and the catalyst is positioned above the crankcase.

In another embodiment, the catalyst is positioned adjacent to the crankcase.

Another embodiment includes an oxygen concentration sensor installed in the exhaust pipe, wherein the catalyst is installed forwardly of the oxygen concentration sensor.

In another embodiment, the exhaust pipe is positioned by the side of the engine so as to extend rearward and inward.

Another embodiment includes an outer pipe covering the periphery of a portion of the exhaust pipe where the catalyst is installed.

In another embodiment, a heat shield plate is disposed on the outside in a vehicle width direction of a portion of the exhaust pipe where the catalyst is installed.

Another embodiment includes an outer pipe covering the periphery of the portion of the exhaust pipe where the catalyst is installed, in which the heat shield plate shields the outer pipe.

In another embodiment, the heat shield plate is attached to the main frame.

Another embodiment includes a silencer connected to a rear end of the exhaust pipe, and the catalyst includes a pre-catalyst for raising the temperature of exhaust gas, and a main catalyst positioned downstream of the pre-catalyst for purifying the exhaust gas. The pre-catalyst is disposed in the exhaust pipe, and the main catalyst is disposed in the silencer.

According to the present invention, a pre-catalyst is disposed in an exhaust pipe to purify exhaust gas. Further, the pre-catalyst is apart from rider's leg, so that damage due to heat from the exhaust pipe is prevented.

Other features and advantages of the invention will be apparent from the following detailed description, taken in conjunction with the accompanying drawings which illustrate, by way of example, various features of embodiments of the invention.

### BRIEF DESCRIPTION OF THE DRAWINGS

FIG. 1 is a side view of a motorcycle according to the present invention.

FIG. 2 is an enlarged view of a portion of FIG. 1.

FIG. 3 is a plan view of an engine and an exhaust pipe of the motorcycle of FIG. 1.

FIG. 4 is a cross sectional view taken along line IV-IV of FIG. 3.

### DETAILED DESCRIPTION OF THE INVENTION

An embodiment of the present invention is now described with reference to the drawings.

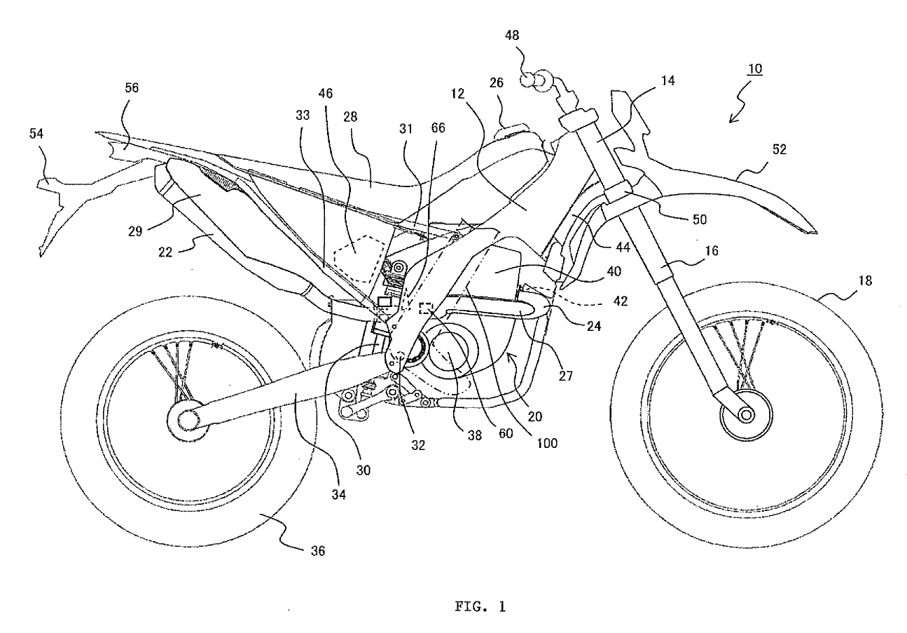

FIG. 1 is a side view illustrating a motorcycle 10 in accordance with an embodiment of the present invention. Motorcycle 10 includes a head pipe 14 below handlebars 48, and a pair of left and right main frames 12 extending from head pipe 14 longitudinally of motorcycle 10. Front forks 16 are attached to head pipe 14 in a manner to steer to the left and right. A front wheel 18 is attached to lower parts of front forks 16. An engine 20 is mounted to main frame 12 and has an exhaust pipe 24 attached thereto. Exhaust gas flows through exhaust pipe 24 into a silencer 22.

A seat rail 31 and a backstay 33 extend upward and rearward from a middle portion of each main frame 12. The middle portion of main frame 12, seat rail 31, and backstay 33 are coupled together to form a generally triangular framework. A rear arm 34 extends from a lower part of main frame 12. Rear arm 34 is attached for up-and-down pivotal movement about a pivot shaft 32 via a rear cushion 30. A rear wheel 36 is attached to a rear part of rear arm 34.

A fuel tank 26 and a seat 28 are attached on a generally central upper portion of motorcycle 10 in a manner to be supported with main frames 12 and seat rails 31. Engine 20 includes a crankcase 38 and a cylinder body 40 and is secured to main frames 12 with securing means such as bolts. In one embodiment, engine 20 is a four-stroke engine. Exhaust pipe 24 is attached to an exhaust opening 42 in a front part of engine 20.

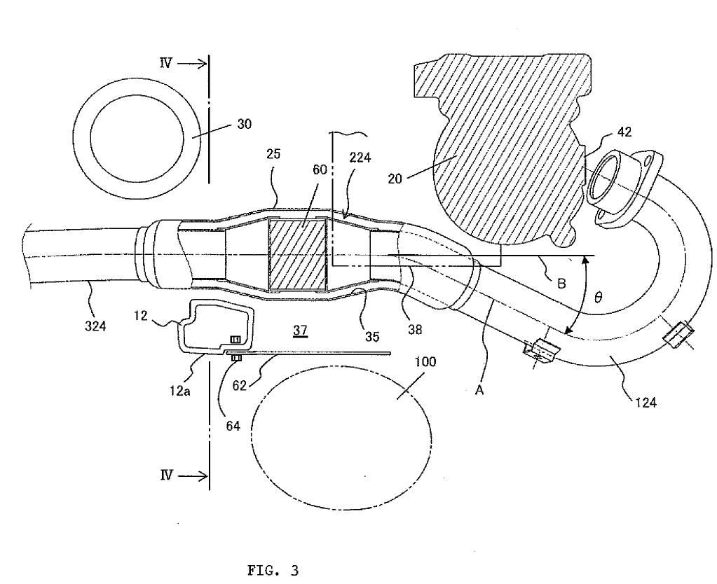

Exhaust pipe 24 extends slightly forward from exhaust opening 42 and then curves and extends rearward. As seen from above, exhaust pipe 24 is positioned between engine 20 and main frame 12 (FIG. 3). Silencer 22 is connected to an outlet of exhaust pipe 24 in front of rear wheel 36 and below seat 28. Exhaust pipe 24 and silencer 22 respectively have protectors 27, 29 attached thereto which prevent dissipation of heat from exhaust gas. A radiator 44 is disposed above engine 20. An air cleaner 46 is disposed behind engine 20 and below seat 28.

Exhaust pipe 24 is attached to exhaust opening 42 of engine 20. Silencer 22 is secured to backstay 33 with a bolt. A front turn signal 50 is provided below handlebars 48. A front fender 52 is attached to the insides of left and right front forks 16. A rear fender 54 and a rear turn signal 56 are provided in an upper rear portion of motorcycle 10. A chain is wound around an output shaft of engine 20 and rear wheel 36 to transmit power.

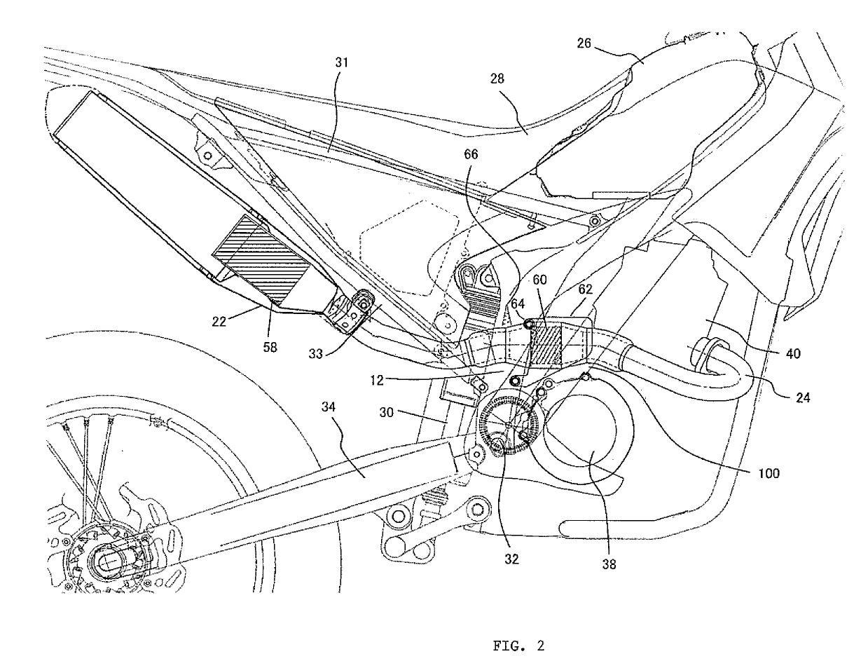

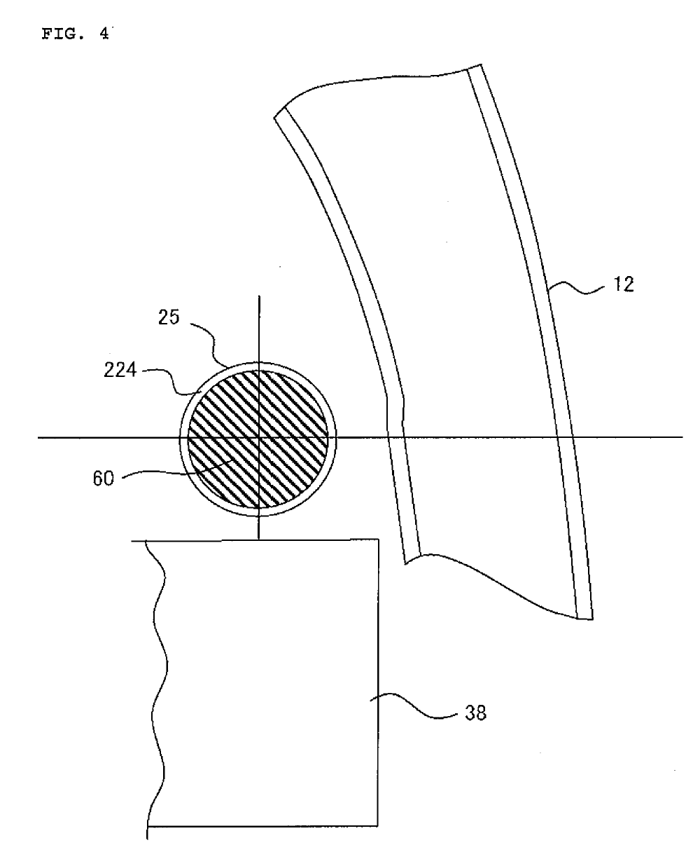

FIG. 2 is an enlarged side view of a portion of motorcycle 10 including engine 20 and exhaust pipe 24. FIG. 3 is a schematic plan view corresponding to FIG. 2, and FIG. 4 is a cross sectional view taken along line IV-IV in FIG. 3.

Exhaust pipe 24 includes a first exhaust pipe 124, a second exhaust pipe 224, and a third exhaust pipe 324 connected together. Exhaust gas is delivered from engine 20, through first exhaust pipe 124 to third exhaust pipe 324, and to silencer 22. To facilitate gas delivery through a predetermined route, these exhaust pipes each have a certain radius of curvature.

First exhaust pipe 124 is connected to exhaust opening 42 of engine 20 at the inlet of exhaust pipe 124, extends slightly forward, and then curves and extends rearward. Second exhaust pipe 224 is connected to an outlet of first exhaust pipe 124 and extends rearward. A middle portion of second exhaust pipe 224 has a larger diameter. Third exhaust pipe 324 is connected to an outlet of second exhaust pipe 224 and extends rearward. An outlet of third exhaust pipe 324 is connected to an inlet of silencer 22.

Alternatively, first exhaust pipe 124, second exhaust pipe 224, and third exhaust pipe 324 can be formed together as a single piece.

Silencer 22 is connected to a rear end of third exhaust pipe 324. A main catalyst 58 is disposed in silencer 22 for purifying exhaust gas. A pre-catalyst 60 is disposed in second exhaust pipe 224 for raising the temperature of exhaust gas. Pre-catalyst 60 is positioned forwardly of main catalyst 58. Main catalyst 58 is a known device for purifying exhaust gas. However, since sole use of main catalyst 58 results in insufficient purification of exhaust gas, pre-catalyst 60 is also provided.

Pre-catalyst 60 uses a catalyst reducing device including platinum, rhodium or the like to deoxidize or oxidize toxic substances contained in exhaust gas. Pre-catalyst 60 exhibits low reducing ability at ambient temperatures. Specifically, immediately after the start of engine 20, it exhibits substantially no reducing ability. Hence, pre-catalyst 60 is positioned closer to exhaust opening 42 of engine 20 to thereby raise the temperature of exhaust gas.

In this embodiment, exhaust pipe 24 is positioned by the side of engine 20 so as to extend rearward and inward, and passes between engine 20 and main frame 12. Pre-catalyst 60 is disposed in a portion of exhaust pipe 24 on the vehicle side of main frame 12.

As shown in FIGS. 2 and 3, exhaust pipe 24 extends slightly forward from exhaust opening 42 of engine 20 and then curves and extends rearward. Exhaust pipe 24 passes above crankcase 38 of engine 20 and by the inside of main frame 12. Exhaust pipe 24 further passes between the inside of main frame 12 and rear cushion 30 and extends rearward.

Exhaust pipe 24 is positioned by the side of engine 20 and extends from the front side of the vehicle toward the rear to be inclined to the inside. More specifically, exhaust pipe 24 passing around engine 20 is located such that its center axis “A” is inclined to the inside at an angle of θ relative to the direction of axis “B” in which the vehicle travels (see FIG. 3). This aims at separating exhaust pipe 24 at high temperatures as far away from a rider's leg (calf) 100 as possible.

Pre-catalyst 60 is disposed adjacent to crankcase 38 and in a portion of exhaust pipe 24 above and closely behind crankcase 38 (see FIG. 4). As a result, pre-catalyst 60 is positioned rearwardly of a lateral side end of engine 20 and by the inside of main frame 12.

In this embodiment, since pre-catalyst 60 is positioned proximate to exhaust opening 42 in exhaust pipe 24, the temperature of pre-catalyst 60 will rise quickly to achieve efficient purification of exhaust gas. In addition, pre-catalyst 60 is positioned inside of an outside end of main frame 12 (see FIG. 3) to be apart from the rider's leg 100. Thus, damage due to heat from pre-catalyst 60 at high temperatures is prevented.

In this embodiment, a portion of the exhaust pipe where pre-catalyst 60 is disposed has a double-pipe structure.

As shown in FIG. 3, second exhaust pipe 224 has pre-catalyst 60 disposed therein. An outer pipe 25 is attached so as to cover the periphery of second exhaust pipe 224. Outer pipe 25 is disposed around second exhaust pipe 224 to define a heat insulating space 35 therebetween. A front end and a rear end of outer pipe 25 are in sealing contact with the periphery of second exhaust pipe 224. Thus, heat insulating space 35 is an enclosed space.

Due to outer pipe 25, the air in enclosed space 35 exerts a heat insulation effect to insulate radiation heat from pre-catalyst 60 at high temperatures (e.g., 900° C.). In addition, since pre-catalyst 60 at high temperatures may cause a change in color or rust on second exhaust pipe 224, outer pipe 25 also serves to hide second exhaust pipe 224 subjected to such change in color or the like.

A heat shield plate 62 is attached to shield outer pipe 25. Heat shield plate 62 is composed of synthetic resin, and is secured to main frame 12 with a bolt 64. Heat shield plate 62 can thus be easily attached. Heat shield plate 62 can be composed of materials other than synthetic resin, such as a metal sheet.

Heat shield plate 62 is disposed on the outside in the vehicle width direction of a portion of exhaust pipe 24 where pre-catalyst 60 is installed. A heat insulating space 37 is thereby defined between exhaust pipe 24 and heat shield plate 62 and prevents damage due to heat from exhaust pipe 24.

Thus, the periphery of pre-catalyst 60 is covered by outer pipe 25, which in turn is shielded by heat shield plate 62, to prevent damage due to heat from pre-catalyst 60.

An oxygen concentration sensor 66 is installed in a portion of exhaust pipe 24 passing through the inside of main frame 12 (see FIG. 1). Pre-catalyst 60 is installed forwardly of oxygen concentration sensor 66 in exhaust pipe 24. Oxygen concentration sensor 66 detects the concentration of oxygen in exhaust gas. The detection value from sensor 66 is used to control a mixture ratio.

As described above, in this embodiment, exhaust pipe 24 is positioned between engine 20 and main frame 12, as seen from above. The catalyst (pre-catalyst 60) is positioned inside of the outside end of main frame 12. Accordingly, the catalyst (pre-catalyst 60) is apart from the rider's leg, so that damage due to heat from exhaust pipe 24 is prevented.

Engine 20 has crankcase 38 on a side in the vehicle width direction. Since the catalyst (pre-catalyst 60) is positioned above crankcase 38, projection of the catalyst (pre-catalyst 60) beyond an outside end of crankcase 38 is reduced. Thus, damage due to heat from the catalyst (pre-catalyst 60) is prevented, and efficient purification of exhaust gas is achieved.

The catalyst (pre-catalyst 60) is positioned adjacent to crankcase 38, and is thereby closer to exhaust opening 42. The temperature of the catalyst (pre-catalyst 60) will thus rise quickly.

Motorcycle 10 in accordance with this embodiment includes oxygen concentration sensor 66 installed in exhaust pipe 24. The catalyst (pre-catalyst 60) is installed forwardly of oxygen concentration sensor 66. Thus, the catalyst (pre-catalyst 60) is closer to exhaust opening 42 and its temperature will rise quickly, which achieves efficient purification of exhaust gas.

Exhaust pipe 24 is positioned by the side of engine 20 so as to extend rearward and inward. The catalyst (pre-catalyst 60) is thereby apart from the rider's leg, so that damage due to heat from exhaust pipe 24 is prevented.

Motorcycle 10 in accordance with this embodiment includes outer pipe 25 covering the periphery of a portion of exhaust pipe 24 where the catalyst (pre-catalyst 60) is installed. As a result, heat insulating space 35 is defined between exhaust pipe 24 and outer pipe 25. Damage due to heat from exhaust pipe 24 can thus be prevented.

Heat shield plate 62 is arranged on the outside in the vehicle width direction of a portion of exhaust pipe 24 where the catalyst (pre-catalyst 60) is installed. As a result, heat insulating space 37 is defined between exhaust pipe 24 and heat shield plate 62. Damage due to heat from exhaust pipe 24 can thus be prevented.

Motorcycle 10 in accordance with this embodiment further includes outer pipe 25 covering the periphery of a portion of exhaust pipe 24 where the catalyst (pre-catalyst 60) is installed. Outer pipe 25 is in turn shielded by heat shield plate 62. Thus, damage due to heat from exhaust pipe 24 is prevented.

Heat shield plate 62 is attached to main frame 12. This facilitates the attachment of heat shield plate 62.

The catalyst includes pre-catalyst 60 for raising the temperature of exhaust gas, and main catalyst 58 positioned downstream of pre-catalyst 60 for purifying the exhaust gas. Pre-catalyst 60 is disposed in exhaust pipe 24, and main catalyst 58 is disposed in silencer 22. Thus, the temperature of exhaust gas is raised through pre-catalyst 60, and purification of exhaust gas is credibly achieved through main catalyst 58.

The particular embodiments of the invention described in this document should be considered illustrative, rather than restrictive. Modification to the described embodiments may be made without departing from the spirit of the invention as defined by the following claims.

1. A motorcycle comprising:
a main frame extending longitudinally;
an engine mounted on the main frame and having an exhaust opening;
an exhaust pipe extending forward from the exhaust opening, curving and then extending rearward; and
a catalyst disposed in the exhaust pipe,
wherein the exhaust pipe is positioned between the engine and the main frame, as seen from above, and
the catalyst is positioned inside of an outside end of the main frame.

2. The motorcycle according to claim 1, wherein
the engine has a crankcase on one side in a vehicle width direction, and
the catalyst is positioned above the crankcase.

3. The motorcycle according to claim 2, wherein the catalyst is positioned adjacent to the crankcase.

4. The motorcycle according to claim 1, further comprising:
an oxygen concentration sensor installed in the exhaust pipe,
wherein the catalyst is installed forwardly of the oxygen concentration sensor.

5. The motorcycle according to claim 1, wherein the exhaust pipe is positioned by the side of the engine so as to extend rearward and inward.

6. The motorcycle according to claim 1, further comprising an outer pipe covering the periphery of a portion of the exhaust pipe where the catalyst is installed.

7. The motorcycle according to claim 6, wherein a heat insulating space is defined between the outer pipe and the exhaust pipe.

8. The motorcycle according to claim 1, wherein a heat shield plate is disposed on the outside in a vehicle width direction of a portion of the exhaust pipe where the catalyst is installed.

9. The motorcycle according to claim 8, wherein a heat insulating space is defined between the heat shield plate and the exhaust pipe.

10. The motorcycle according to claim 8, further comprising:
an outer pipe covering the periphery of the portion of the exhaust pipe where the catalyst is installed,
wherein the heat shield plate shields the outer pipe.

11. The motorcycle according to claim 8, wherein the heat shield plate is attached to the main frame.

12. The motorcycle according to claim 1, further comprising a silencer connected to a rear end of the exhaust pipe, wherein the catalyst includes:
a pro-catalyst for raising the temperature of exhaust gas; and
a main catalyst positioned downstream of the pre-catalyst for purifying the exhaust gas,
wherein the pre-catalyst is disposed in the exhaust pipe, and
the main catalyst is disposed in the silencer.
